(19) United States
(12) Patent Application Publication
(10) Pub. No.: US 2014/0310174 A1
(43) Pub. Date: Oct. 16, 2014

(54) METHODS FOR CONDUCTING ELECTRONIC PAYMENT TRANSACTIONS WITH SCANNABLE CODES

(71) Applicant: Thomas W. Heeter, Corning, CA (US)

(72) Inventor: Thomas W. Heeter, Corning, CA (US)

(21) Appl. No.: 14/079,402

(22) PCT Filed: May 13, 2011
(86) PCT No.: PCT/US2011/000855

§ 371 Date: Jun. 24, 2014

(51) Int. Cl. G06Q 20/40; H04W 12/06; H04L 29/06; G06Q 20/10

(52) U.S. Cl. CPC G06Q 20/40; G06Q 20/10; H04W 12/06; H04L 63/083
USPC 705/44; 455/411

(57) ABSTRACT

One embodiment of the invention provides for making electronic payments by scanning a merchant 2D code located near the point of sale with the customer's cell phone and transmitting the code or data embodied by the code to a payment center where the merchant's account can be credited and the customer's account debited without transmitting account information over the airwaves. In another embodiment of the invention, both parties transmit the same randomly generated 2D code or data embodied by the code to the payment center where they are matched to each other and to the buyer and seller to process the transaction. In a further embodiment of the invention, an inked tattoo or barcode marking is employed as a password to authorize access to smartphone applications for example, to make an electronic payment over a threshold amount.

### CROSS REFERENCES TO RELATED APPLICATIONS

This application is a continuation in part of and claims the benefit of copending US application serial number PCT/US2011/00855 titled METHODS FOR CONDUCTING ELECTRONIC PAYMENT TRANSACTIONS WITH SCANNABLE CODES” which designated the United States and had an international filing date of 13 May 2011. Application serial number PCT/US2011/00855 had an international publication number of WO 2012/158133, an international publication date of 22 Nov. 2012.

### FIELD OF THE INVENTION

The present invention relates to the use of machine-readable codes for the purposes of conducting monetary and credit transactions in a secure manner.

### BACKGROUND OF THE INVENTION

The disclosure of my earlier patent, U.S. Pat. No. 5,878,155, issued Mar. 2, 1999 is incorporated herein by reference. In U.S. Pat. No. 5,878,155 at column 2, lines 40-42, the possibility employing temporary tattoos for the verification method is disclosed.

In my PCT patent application number PCT/US10/02986 filed Nov. 17, 2010, the disclosure of which is incorporated herein, there is disclosed a further security improvement by employing a series of temporary tattoos, each valid only for a temporary period of time, or, alternatively, a temporary tattoo, label, decal or the like carrying a barcode or the like coupled to an identity confirmation step that employs a buyer's cell phone.

### SUMMARY OF THE INVENTION

The first embodiment of the present invention is described as a method for conducting an electronic payment. The method employs a seller bar code encoding information electronically linkable to a seller's account, the seller's account belonging to an intended recipient of the electronic payment. A smart-phone with a camera function is employed by a buyer for capturing an image of the seller bar code. A wireless communication system is employed for transmitting data, including data representative of the seller bar code image, from the camera to a remote payment center. Computer applications are present on the smart-phone and at the remote payment center to enable data transmission over the wireless communication system and to authorize the payment center to transfer funds from a buyer's account, typically belonging to the smart-phone owner, to the seller's account. The method is carried out by providing an image of the bar code at a point of sale for goods or services, capturing or scanning an image of the bar code with the camera function of the smart phone, processing the image with the smart-phone application to form a wirelessly transmittable data file, wirelessly transmitting the data file from the smart-phone to the payment center, wirelessly transmitting a data file representative of a payment amount from the smart-phone to the data center, together or separately with the image data, electronically debiting the buyer's account by the payment amount, electronically crediting the seller's account by the payment amount, and transmitting data representative of the crediting of the seller's account to at least the seller.

In a preferred first embodiment of the invention, only an identifying barcode for the seller is transmitted over the airwaves, and the seller's account associated with the barcode is preferably configured, for security, only for the acceptance of electronic payments.

The second embodiment of the invention also is described as a method for conducting an electronic payment. The method employs a randomly generated code, preferably in machine readable form as a 2-D barcode. An application and a first hardware set is employed to generate the code and display a two-dimensional barcode image representative of the code, and optionally additional information. An application and a second hardware set including a camera function is employed for capturing the displayed barcode image from the first hardware set. Both hardware sets then transmit data strings representative of the barcode image to a remote payment center. At least one of the data strings further includes payment amount data. An application on a third hardware set at the payment center is provided for associating the first data string and the second data string with each other and authorizing an electronic transfer of funds in the amount of payment between an account associated with the first hardware set and an account associated with the second hardware set. The method is carried out by generating and displaying the barcode image on the first hardware set and transmitting a first data string to the remote payment center. The displayed barcode image is captured, or read, by the second hardware set and the second data string is transmitted to the remote payment center. A data string representative of the amount of payment is also transmitted to the remote payment center. At the remote payment center, the first data string is associated with the second data string and the amount of payment, and the electronic transfer of funds in the amount of payment between the account associated with the first hardware set and the account associated with the second hardware set is authorized.

In a preferred second embodiment of the invention, a further security improvement is provided by employing a single-use barcode generated algorithmically, preferably randomly, by either the buyer's or seller's smart-phone-camera-viewer device. Where the image is generated by the seller's device, the invention can be carried out as above, and the image can further encode the amount of payment. Physically small 2D barcodes can encode hundreds of digits.

The third embodiment is described as a method for password-protecting a smart-phone application where the smart-phone has a camera function. The method is carried by providing a user of the smart phone with an inked two-dimensional barcode mark, and providing selected of the user's smart-phone applications with an unlock application functionally dependent on capturing or reading the image of the two-dimensional barcode mark. The method is carried out by capturing the image of the barcode with the camera function of the smart-phone, and processing the image with the unlock application to access the selected application.

In the preferred third embodiment of the invention, a inked tattoo or barcode marking is employed to authorize access to selected smartphone applications or as an extra security layer for the above methods for payments if they are above a threshold amount.

### BRIEF DESCRIPTION OF THE DRAWINGS

FIG. 1 is a flowchart illustrating a first embodiment of the invention.

FIG. 2 is a flowchart illustrating a second embodiment of the invention.

FIG. 3 is a flowchart illustrating another way of carrying out the second embodiment of the invention.

FIG. 4 is a flowchart is a flowchart illustrating a third embodiment of the invention.

FIG. 5 is a flowchart illustrating further aspects of the third embodiment of the invention.

FIG. 6 is a flowchart illustrating further aspects of the first embodiment of the invention.

FIG. 7 is a flowchart illustrating further logic for the FIG. 6 flowchart.

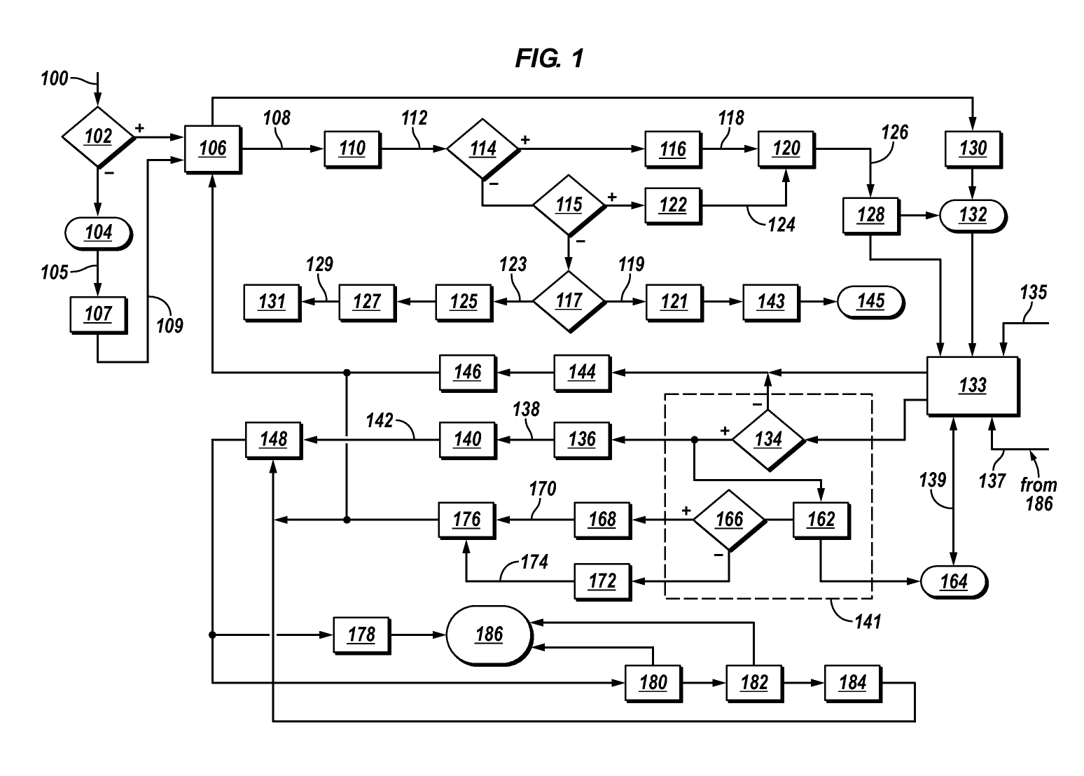

### DETAILED DESCRIPTION OF THE INVENTION

The first embodiment of the invention employs a seller bar code encoding information electronically linkable to a seller's account, the seller's account belonging to an intended recipient of the electronic payment. A smart-phone with a camera function is employed for capturing an image of the seller bar code, or reading it. A wireless communication system is employed for transmitting data, including data representative of the seller bar code image, from the camera to a remote payment center. Computer applications are present on the smart-phone and at the remote payment center to enable data transmission over the wireless communication system and to authorize the payment center to transfer funds from the buyer's account to the seller's account. The buyer's account typically belongs to the smart-phone owner and the seller's account is typically pre-associated with the bar code. The method is carried out by providing an image of the bar code at a point of sale for goods or services, capturing an image of the bar code, or reading it, with the camera function of the smart phone, processing the image with the smart-phone application to form a wirelessly transmittable data file, wirelessly transmitting the data file from the smart-phone to the payment center, wirelessly transmitting a data file representative of a payment amount from the smart-phone to the data center, electronically debiting the buyer's account by the payment amount, electronically crediting the seller's account by the payment amount, and transmitting data representative of the crediting of the seller's account to the seller.

The bar code is preferably a two-dimensional bar code. The bar code can further encode a telephone number for establishing contact with the payment center, which the smart phone application reads and dials, or other seller information. The user of the smart-phone can enter, using their keypad, a payment amount which is transmitted to the payment center, and notification of payment can be sent from the payment center to the seller's device at the point of sale. The bar code can be printed on a sign, or it can be electronically generated and displayed on a viewer. Where the code is electronically generated, it can further encode the amount due, which the application on the seller's phone reads and displays, for example, for confirmation by the buyer.

As an example of the first embodiment of the invention, suppose the merchant says the customer owes $25.00. The customer enters $25.00 into their smartphone, scans the merchant's label, and commands send, which (through an application residing in the smartphone), transmits the payment authorization to the payment center, where, contingent on acceptance by the payment center and optionally the merchant, the account associated with the smartphone is debited $25.00 and the account associated with the label is credited $25.00. Notification of the crediting of the merchant account is transmitted to the pay point associated with the merchant's label, where the merchant (and/or customer) can optionally be required to accept the payment, the acceptance being transmitted back to the payment center for the storing of an electronic record of the transaction.

The method takes care of paying the merchant without transmitting customer account information over the airwaves. The merchant account can be made secure by being only configured to accept payments.

The second embodiment of the invention makes use of a randomly generated code. An application and a first hardware set is employed to generate the code and display a two-dimensional barcode image representative of the code. Additional nonrandom information may be encoded as well. An application and a second hardware set including a camera function is employed for capturing or reading the displayed barcode image from the first hardware set. Both hardware sets then transmit data strings representative of the barcode image to a remote payment center. At least one of the data strings further includes payment amount data. An application on a third hardware set at the payment center is provided for associating the first data string and the second data string with each other and authorizing an electronic transfer of funds in the amount of payment between an account associated with the first hardware set and an account associated with the second hardware set. The method is carried out by generating and displaying the barcode image on the first hardware set and transmitting a first data string to the remote payment center. The displayed barcode image is captured or read by the second hardware set and the second data string is transmitted to the remote payment center. A data string representative of the amount of payment is also transmitted to the remote payment center. At the remote payment center, the first data string is associated with the second data string and the amount of payment, and the electronic transfer of funds in the amount of payment between the account associated with the first hardware set and the account associated with the second hardware set is authorized.

The barcode can be generated by either the seller's or the buyer's equipment. Thus, either or both of the first hardware set and the second hardware set can comprise a smartphone. The data string representative of the amount of payment can be transmitted to the remote payment center by either one of the first hardware set and the second hardware set, and the remote payment center can forward the data string representative of the amount of payment to the other of the first hardware set and the second hardware set for confirmation, and the hardware set which receives the forwarded data string can transmit a data string back to the payment center representative of acceptance of the amount.

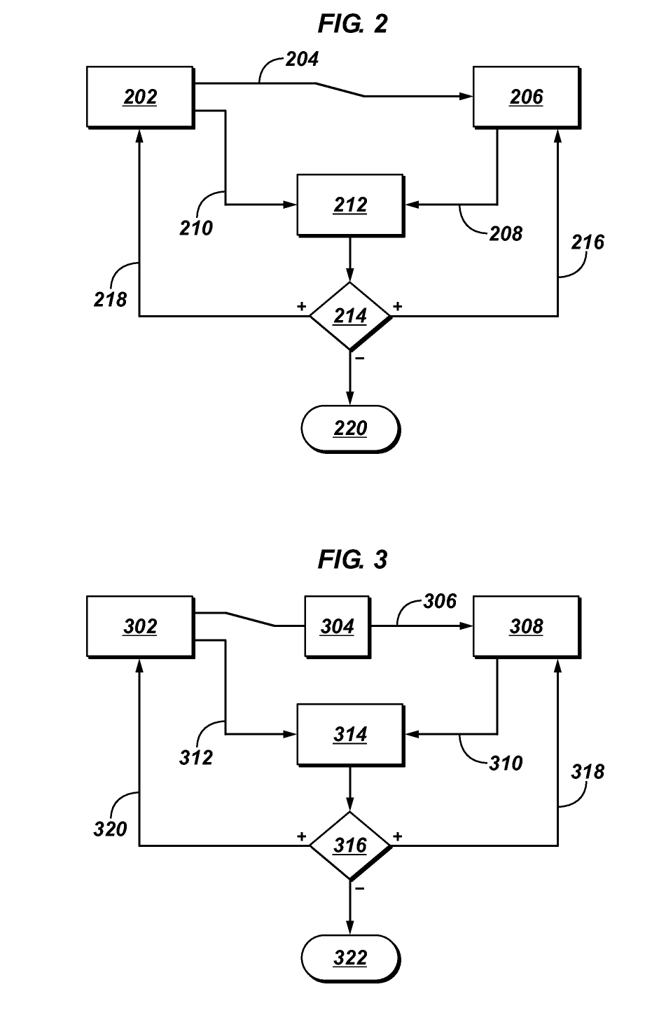

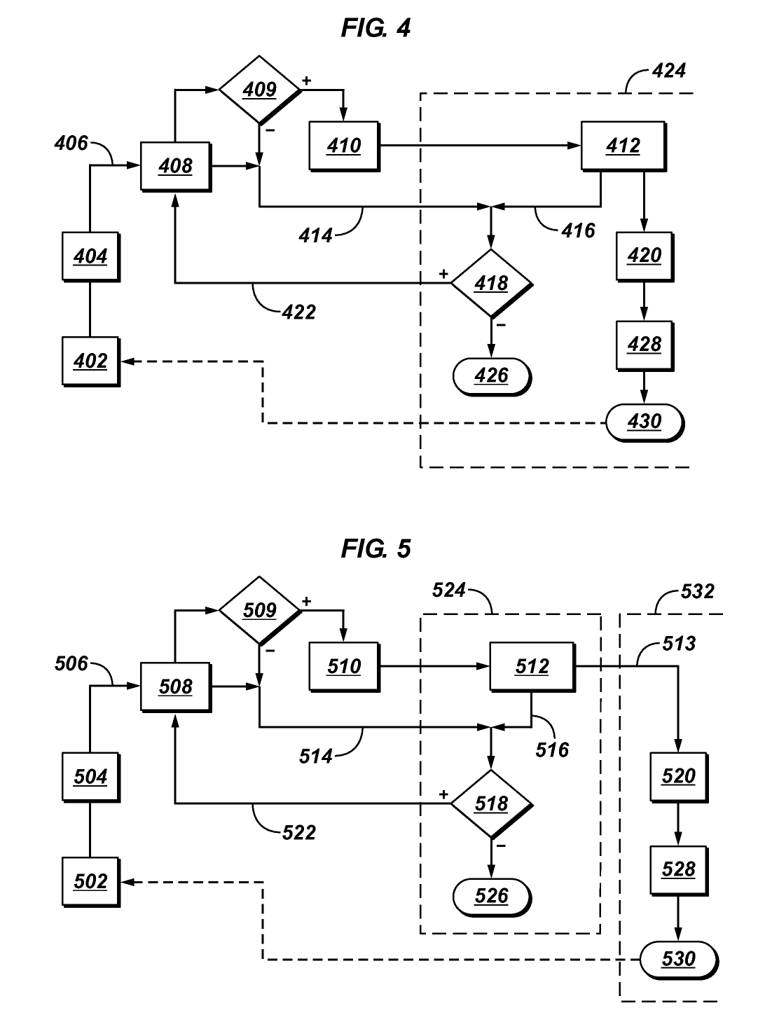

In a preferred embodiment of the second embodiment of the invention, as illustrated in FIG. 2, the customer's phone dynamically generates a unique 2D Bar Code for transaction and a micromerchant's phone takes a photograph of the 2D bar code image or otherwise decodes the embedded code. After validation, the Payment Center sends a unique generated code for the transaction to both customer and merchant. Alternatively, the second embodiment can be carried out as shown in FIG. 3, where the merchant's phone dynamically generates a unique 2D bar code for the transaction, the customer phone takes a picture (static image) of the 2D barcode or decodes the embedded code, and the payment center receives (along with transaction data) the unique 2D bar code or embedded code.

As an example of a second embodiment of the invention, a customer wanting to pay a merchant commands the production, via an application residing in their smartphone, of a data matrix code image on the viewer of their smartphone. The data matrix code is single-use, at least a portion of the code being randomly generated by the customer's smartphone. The merchant scans the customer's data matrix code image and transmits, via an application residing the merchant hardware, the data matrix code image, the amount of the transaction, and merchant information to the payment center associated with the data matrix code image. The buyer transmits the data matrix code to the payment center, where it is matched up to the merchant transmission, and contingent on the data matrix image being unique, associated with the buyer's account for debiting and the merchant's account for crediting in the amount of the transaction. Notification of the crediting of the merchant account (or rejection of the code) is transmitted to the paypoint associated with the merchant's transmission, and the merchant (and/or customer) can optionally be required, if the transaction is to proceed, to accept the payment, the acceptance being transmitted back to the payment center for the storing of an electronic record of the transaction. Alternatively, the transaction can begin by the merchant generating the data matrix code image containing a portion which is randomly generated and the buyer captures an image of the merchant's code for transmission to the payment center. The transaction then proceeds, mutatis mutandis, through the crediting notification/confirmation steps as above.

In the second embodiment of the invention, the customer's account is protected against unauthorized debiting by a single-use lengthy random code string which must be matched and preferably corroborated in some way in order for the debit to proceed.

The third embodiment of the invention is described as a method for password-protecting a smart-phone application where the smart-phone has a camera function. The method is carried by providing a user of the smart phone with an inked two-dimensional barcode mark, and providing selected of the user's smart-phone applications with an unlock application functionally dependent on scanning or capturing an image of the inked two-dimensional barcode mark. The method is carried out by scanning or capturing an image of the inked barcode with the camera function of the smart-phone, and processing the image with the unlock application to access the selected application.

The smartphone application can be configured to time-out the period during which it will accept a given code. In such case the scanned mark unlocks the application only if the mark is scanned during a predetermined time period. The user would have to change the bar code and reset the application periodically in order to maintain functionality and avoid being locked out of applications on their own phone. The inked two-dimensional bar code could be printed on the skin of the user or on a sticker or label applied to a personal object of the user. One application that would be desirable to password protect in the manner of the third embodiment of the invention would be where the smartphone user is attempting to make an electronic transfer over a predetermined amount, say over $100. In that case, the financial account of the user would be debited (or credited) in the amount of the electronic payment only after the printed barcode was scanned.

As an example of a third embodiment of the invention, a smartphone user also carries an image of a data matrix code. The code can be in the form of a sticker that is carried on a card, for example. The user's smartphone is provided with an application that only permits certain applications on the smartphone to be used after the data matrix code is scanned. The application can be used to lock up payment applications, or used to confirmed payments of over a threshold amount.

In the embodiments of the invention described herein, the instructions to effect payment are routed from the payor, typically the buyer, to the payor's financial institution, without being routed through the payee, typically the seller. With the inventive data flow, the consumer data is not shared with the merchant, affording the consumer with greater security and privacy, and less risk for fraud. The payee bar code, which can be any scannable code, can further be encrypted prior to transmission with a cipher which can be decrypted by the payor's financial institution. The payor identity verification step can also include a scannable code which can be in the form of an identifying photograph which has been pixilated, for example, and which can also be subjected to encryption/decryption before and after transmission. The payor identity can be validated as needed, using combinations of biometrics, government identifications, smartphone data, and passwords or other items of personal knowledge. The system can replace a check system, but with higher security, and, like a check, the critical elements are payor identity, payee identity, and amount. The system can also be used to effect other forms of mobile transactions, such all or part payment by discounts, credits, points, or coupons. In such case, the user's mobile device will query the user as to payment type as an additional step.

The Figures show data flow and logic which can be used to carry out preferred embodiments of the invention. Reference numerals used in the Figures are as follows:
100 Do you have SmartPay?
102 Customer has Smartpay?
104 Dial or Text number of Server to Customer phone
105 Customer requests Smartpay Appl by phone
106 Customer (Payment Sender)
107 Telephony server
108 Amount
109 Smartphone application downloaded to Customer phone
110 Mobile Application entering amount
112 Amount
114 Has decal to scan?
115 Receiver has account?
116 Mobile Application Scanning Decal
117 Is Receiver Merchant or other consumer?
118 Decal Information
119 Merchant
120 Mobile Application Sending payment information to Payment Center
121 Send link to Web portal
122 Entering in Receiver's phone #
123 Consumer
124 Mobile phone #
125 Send download link
126 Payment information (first name, email, phone #, merchant phone #, trxn # or other info)
127 Telephony server sends Link
128 Payment Server Checking customer eligibility (e.g. funds)
129 SMS link sent to smartphone
130 Mobile Application Payment Server Creating new Smartpay customer account
131 Customer smartphone
132 SmartPay Customer Account
133 Payment Server
134 Is customer eligible?
135 Customer Data
136 Payment Server sending approval to customer via email and/or SMS Messaging
137 Merchant account data from 186
138 Payment Info
139 Paypal or comparable payment gateway may serve as payment server
140 Mobile Application showing transaction approval (also sent to merchant)
141 Inside payment server
142 Payment information
143 Merchant's desktop, notebook, slate or tablet PC
144 Payment Server Sending Error message to customer via Mobile App
145 Merchant signup
146 Mobile Application Showing transaction failure to customer
148 Merchant (Payment Receiver)
162 Payment Server completes transaction via Paypal or comparable payment gateway
164 Paypal or other comparable payment gateway
166 Did payment gateway successfully fund transaction?
168 Payment server Sending confirmation to customer and Merchant via Text and Email
170 Confirmation
172 Payment Server Sending Transaction failure information to Customer and Merchant
174 Failure information via text and email
176 Mobile App Showing/Notifying Transaction confirmation or Failure
178 Mobile App/Payment Server Creating Smartpay Merchant Account
180 Payment Server Logging into SmartPay Merchant Account
182 Payment Server Generating Decal with Merchant information
184 Payment Server Printing Decal
186 SmartPay Merchant Account
202 Customer's Phone (internally generates dynamic photo code image)
204 click (micro)merchant captures image
206 (Micro)merchant phone
208 (Micro)merchant phone sends static image (or decodes and sends unique value) to
210 Customer phone sends static image to (or decodes and send unique value) to
212 Payment Center
214 Equal?
216 If yes, payment center sends confirmation code or unique value to merchant and customer
218 Generated Confirmation Code
220 Reject transaction
302 Merchant's phone (internally generates dynamic photo code image)
304 Display 2D image by merchant
306 click—customer phone captures merchant image
308 Customer phone
310 Customer phone sends static image (or decodes and sends unique value to)
312 Merchant's phone sends static image (or decodes and sends unique value to)
314 Payment center
316 Static image or digital code embedded processing
318 Confirmation code to customer
320 Confirmation code to merchant
322 Reject transaction
402 wallet card
404 scan
406 digitize
408 Customer phone
409 Generate new code?
410 Customer regenerates new code
412 Smart Lock database stores code
414 input (2D code)
416 Read stored 2D code value from 412
418 Equal?
420 Printer
422 Unlock phone
424 Server
426 Keep locked
428 Sticker for Wallet card
430 transmit to customer
502 Wallet card
504 Scan
506 Digitize
508 Customer Phone
509 Generate new code
510 Customer's phone generates new code
512 Customer's phone internally stores generated code
513 to printer or external center
514 Input 2D bar code
516 Read stored 2D bar code value from 512
518 Equal?
520 printer
522 Unlock phone
524 Inside phone (Steps 516-526)
526 Keep locked
528 Sticker for wallet card
530 Print out locally or Transmit to Customer from Processing Center
532 External printer or processing Center
600 Do you have SmartPay?
602 Customer has Smartpay?
604 Dial or Text number of Server to Customer phone
605 Customer requests Smartpay Appl by phone
606 Customer (Payment Sender)
607 Telephony server
608 Amount
609 Smartphone application downloaded to Customer phone
610 Mobile Application entering amount
612 Amount
614 Receiver has decal to scan
615 Receiver has account?
616 Mobile Application Scanning Decal
617 Is Receiver Merchant or other consumer?
618 Decal Information
619 Merchant
620 Mobile Application Sending payment information to Payment Center
621 Send link to Web portal
622 Entering in receiver's phone #
623 Consumer
624 Mobile phone #
625 Send download link
626 Payment info. (first name, email, phone #, amt, merchant phone #, trxn# or other info)
627 Telephony server sends Link
628 Payment Server Checking customer eligibility (e.g. funds, name, etc)
629 SMS link sent to smartphone
630 Mobile Application Payment Server Creating new Smartpay customer account
631 Customer smartphone
632 SmartPay Customer Account
633 Payment server
634 Is customer eligible?
635 Customer Data
636 Payment Server sending approval to customer via email and/or SMS Messaging
637 Merchant account data from 686
638 Payment Info
639 Paypal or comparable payment gateway may serve as payment server
640 Mobile Application showing transaction approval (also sent to merchant)
641 Inside payment server
642 Payment information
643 Merchant's desktop, notebook, slate or tablet PC
644 Payment Server Sending Error message to customer via Mobile App
645 Merchant signup
646 Mobile Application Showing transaction failure to customer
648 Merchant (Payment Receiver)
650 Mobile Application Receiving Merchant's request for funds
652 Authorize Response
654 Mobile Application Sending Merchant's request for funds
656 Authorize Response
658 Is transfer authorized?
660 Payment server evaluates request
662 Payment Server completes transaction via Paypal (or comparable gateway)
664 Paypal or comparable payment gateway
666 Did payment gateway successfully fund transaction?
668 Payment server Sending confirmation to customer and Merchant via Text and Email
670 Confirmation
672 Payment Server Sending Transaction failure information to Customer and Merchant
674 Failure information via text and email
676 Mobile App Showing/Notifying Transaction confirmation or Failure
678 Mobile App/Payment Server Creating Smartpay Merchant Account
680 Payment Server Logging into SmartPay Merchant Account
682 Payment Server Generating Decal with Merchant information
684 Payment Server Printing Decal
686 SmartPay Merchant Account
702 Customer Smart Phone
704 Display request for payment from merchant
706 Customer selects funding source or exit
707 Exit
708 Customer selects debit, credit, or paypal
710 Customer selects Continue
712 Customer selects Rewards Card
714 Confirms amount?
716 Re-enter or Exit
718 Cash Back?
720 Process cash back if approved (amount entered, confirmation of receipt, inform clerk)
722 To payment server
724 Query change to charity
726 If approved, process charity request ($1.00 less decimal part of bill)
728 To payment server
730 Mobile application scans decal
732 Decal information is transmitted
734 To payment server
736 Confirmation to merchant with cash back amount
740 Customer is given cash back
746 Print receipt?
748 Printer
750 Query whether Seller to be added to contact list
752 Seller added to contact database
754 Exit

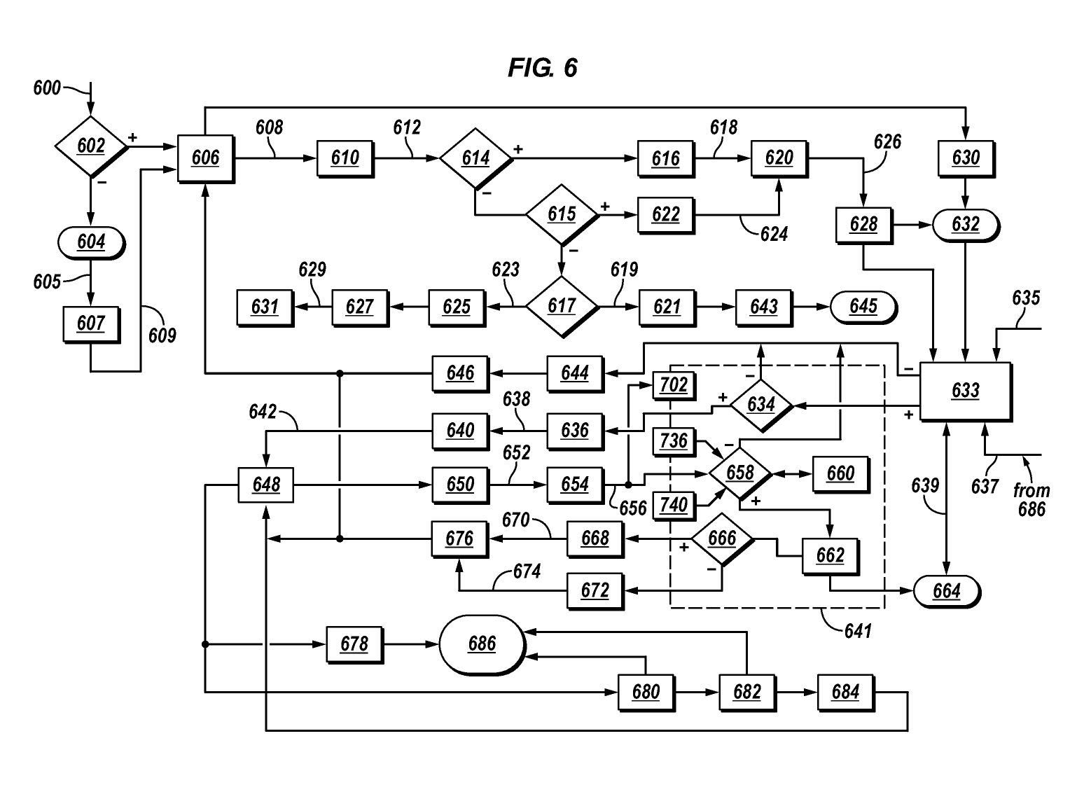

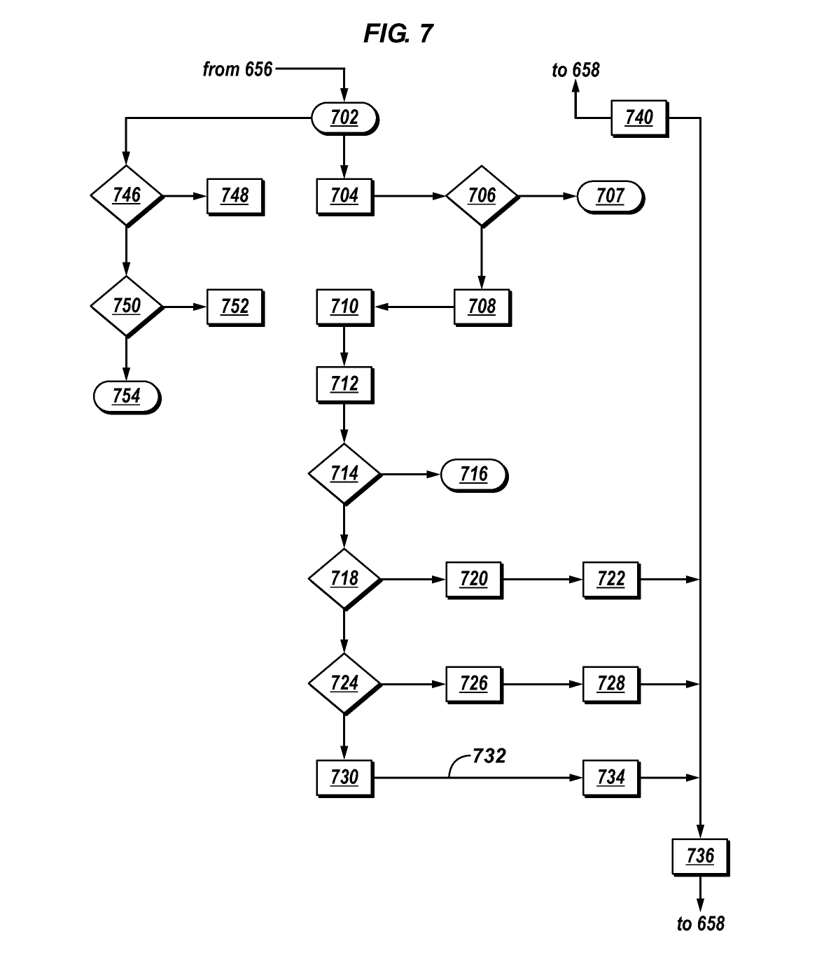

FIGS. 6 and 7 are connected in that the merchant initiates the request for payment 650-656, which then goes to 702, and after the user/consumer has made choices, the flow goes back to the Payment Server to authorize the transfer (658-660).

While certain preferred embodiments have been described herein, the invention is not to be construed as being so limited, except to the extent that such limitations are found in the claims.

What is claimed is:

1. A method for conducting an electronic payment, said method employing
a seller bar code encoding information solely to enable electronic payment to a seller's account, said seller's account belonging to an intended recipient of the electronic payment,
a buyer's smart-phone with a camera function for scanning or capturing an image of the seller bar code and a keypad for entering a payment amount,
a remote electronic payment center for maintaining a buyer's account and making electronic payments from the buyer's account,
a wireless communication system for transmitting data, including data representative of the seller bar code image, and the payment amount, to the remote electronic payment center,
and applications present on the smart-phone and at the remote payment center to enable data transmission of the data over the wireless communication system from the buyer's smart-phone to the remote electronic payment center using a send command and to authorize the remote electronic payment center to electronically transfer funds from a buyer's account associated with the buyer's smart-phone to the seller's account,
said method comprising
providing an image of the seller bar code at a point of sale for goods or services,
scanning or capturing an image of the seller bar code with the camera function of the smart phone,
processing the image with the smart-phone application to form a wirelessly transmittable seller data file,
wirelessly transmitting the seller data file from the smart-phone to the electronic payment center,
wirelessly transmitting a payment data file representative of a payment amount from the smart-phone to the electronic payment center,
electronically debiting the buyer's account by the payment amount,
electronically crediting the seller's account by the payment amount, and
transmitting data representative of the crediting of the seller's account to the seller.

2. A method as in claim 1 wherein the seller bar code is a two-dimensional bar code.

3. A method as in claim 1 wherein a user of the smart-phone enters a payment amount which is electronically transmitted to the electronic payment center.

4. A method as in claim 2 wherein the seller bar code is printed on a label or sign.

5. A method as in claim 2 wherein the seller bar code is electronically generated and is displayed on a viewer.

6. A method as in claim 5 wherein the seller bar code further encodes the amount of payment.

7. A method for a user to password-protect a selected smart-phone application residing on the user's smart-phone,
said smart-phone having a camera function,
said method comprising
providing the user of the smart phone with an inked two-dimensional barcode mark,
providing the user's smart-phone application with an unlock application functionally dependent on scanning or capturing an image of the inked two-dimensional barcode mark with the camera function of the smart-phone and determining that the scanned or captured image is equal to a previously stored image,
scanning or capturing an image of the barcode with the camera function of the smart-phone, and
processing the image with the unlock application to access the password-protected smartphone application,
wherein the user selects the smart-phone application to be protected by the unlock application.

8. A method as in claim 7 wherein the scanned or captured mark unlocks the application only if the mark is scanned or captured during a predetermined time period.

9. A method as in claim 7 wherein the inked two-dimensional bar code is printed on the skin of the user or a sticker applied to a personal object of the user.

10. A method as in claim 7 wherein the selected smartphone application is for making an electronic payment over a predetermined amount.

11. A method as in claim 10 further comprising
debiting a financial account of an owner of the smartphone in the amount of the electronic payment.

12. A method for conducting an electronic payment, said method employing
a sign displaying a seller bar code encoding information electronically linkable to a seller's account, said seller's account belonging to an intended recipient of the electronic payment,
a smart-phone with a camera function for scanning or capturing an image of the seller bar code,
a remote electronic payment center for maintaining a buyer's account and making electronic payments from the buyer's account,
a wireless communication system for transmitting data, including data representative of the seller bar code image, from the camera to the remote electronic payment center,
and applications present on the smart-phone and at the remote payment center to enable data transmission over the wireless communication system and to authorize the remote electronic payment center to electronically transfer funds from a buyer's account associated with the smart-phone owner to the seller's account,
said method comprising
displaying the sign at a point of sale for goods or services,
scanning or capturing an image of the seller bar code with the camera function of the smart phone,
processing the image with the smart-phone application to form a wirelessly transmittable seller data file,
wirelessly transmitting the seller data file from the smart-phone to the electronic payment center,
entering a payment amount using a keypad of the smartphone,
wirelessly transmitting a payment data file representative of the payment amount from the smart-phone to the electronic payment center,
electronically debiting the buyer's account by the payment amount,
electronically crediting the seller's account by the payment amount,
transmitting data representative of the crediting of the seller's account to the seller.

13. A method as in claim 12 wherein the seller bar code is a two-dimensional bar code consisting of only an identifying barcode for the seller.

14. A method as in claim 12 wherein a user of the smart-phone enters a payment amount which is electronically transmitted further electronically transmits an image of a user bar code to the electronic payment center.

15. A method for conducting an electronic payment, said method employing
a scannable machine-readable code encoding information sufficient to enable electronic payment to a payee's account, said payee's account belonging to an intended recipient of the electronic payment,
a payor's smart-phone with a camera function for scanning or capturing an image of the payee's scannable machine-readable code and a keypad for entering a payment amount,
a remote electronic payment center for maintaining a payor's account and making electronic payments from the payor's account,
a wireless communication system for transmitting data, including data representative of the payee's scannable machine-readable code, the payment amount, and the payor's identity, to the remote electronic payment center,
and applications present on the smart-phone and at the remote payment center to enable data transmission of the data over the wireless communication system from the payor's smart-phone to the remote electronic payment center using a send command and to authorize the remote electronic payment center to electronically transfer funds from a payor's account associated with the payor's smart-phone to the payee's account,
said method comprising
providing a scannable image of the payee's scannable machine-readable code at a point of sale for goods or services,
the payor scanning or capturing an image of the payee's scannable machine-readable code with the camera function of the smart phone,
the payor processing the scannable machine-readable image with the smart-phone application to form a wirelessly transmittable payee data file,
the payor wirelessly transmitting the payee data file from the payor's smart-phone to the electronic payment center,
the payor wirelessly transmitting a payment data file representative of a payment amount from the payor's smart-phone to the electronic payment center,
electronically debiting the payor's account by the payment amount,
electronically crediting the payee's account by the payment amount, and
transmitting data representative of the crediting of the payee's account to the payee.

16. A method as in claim 15 further comprising
the payor wirelessly transmitting identity validation data for the payor from the payor's smart-phone to the electronic payment center.

17. A method as in claim 15 wherein
the payee's scannable machine-readable code encodes information only to enable electronic payment to the payee's account.

18. A method as in claim 15 wherein the scannable image of the payee's scannable machine-readable code is a 2-D bar code in printed form.
